(19) United States
(12) Patent Application Publication
(10) Pub. No.: US 2007/0226042 A1
(43) Pub. Date: Sep. 27, 2007

(54) Apparatus and method for improved forecasting

(75) Inventor: John Malcolm MacGregor, Ascot (GB)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/390,870

(22) Filed: Mar. 27, 2006

(51) Int. Cl. G07G 1/00

(52) U.S. Cl. 705/10

(57) ABSTRACT

A computer-readable medium to direct a computer to function in a specified manner includes executable instructions to: generate a data series characterizing data values; identify any unreliable pattern present in the data series; and determine if a forecast should be made for the unreliable pattern.

### BRIEF DESCRIPTION OF THE INVENTION

The present invention relates generally to data processing. More particularly, the present invention relates to a technique for efficiently using computing resources to predict the future performance of an enterprise.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

The present invention relates to the analytical and reporting aspects of BI. Analyzing and predicting the effect that business records have on an enterprise has become increasingly more valuable and complex. A business record or business data value is a measure of the performance of an enterprise (e.g., commercial, governmental, non-profit, etc.). The business data value may be financial, human resource, marketing, sales, customer or supplier information. While there are existing tools that use recorded business records as a predictive driver to evaluate the future performance of an enterprise, these tools inefficiently consume computing resources by engaging in superfluous operations.

Therefore, it would be desirable to provide a new technique that efficiently utilizes business data values as a predictive tool in assessing the future performance of an enterprise. In particular, it would be desirable to provide a method that maximizes the availability of computing resources and reliability of data when forecasting data values.

### SUMMARY OF THE INVENTION

The invention includes a computer-readable medium to direct a computer to function in a specified manner. The computer-readable medium stores executable instructions to: generate a data series characterizing data values; identify an unreliable pattern present in the data series; and determine if a forecast should be made for the unreliable pattern.

The invention also includes a computer implemented method of processing data, comprising: creating data values; identifying an unreliable pattern in the data values; and determining if a forecast should be made for the unreliable pattern.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that may be operated in accordance with an embodiment of the invention.

FIG. 2 illustrates processing operations performed in accordance with an embodiment of the invention.

### DETAILED DESCRIPTION OF THE INVENTION

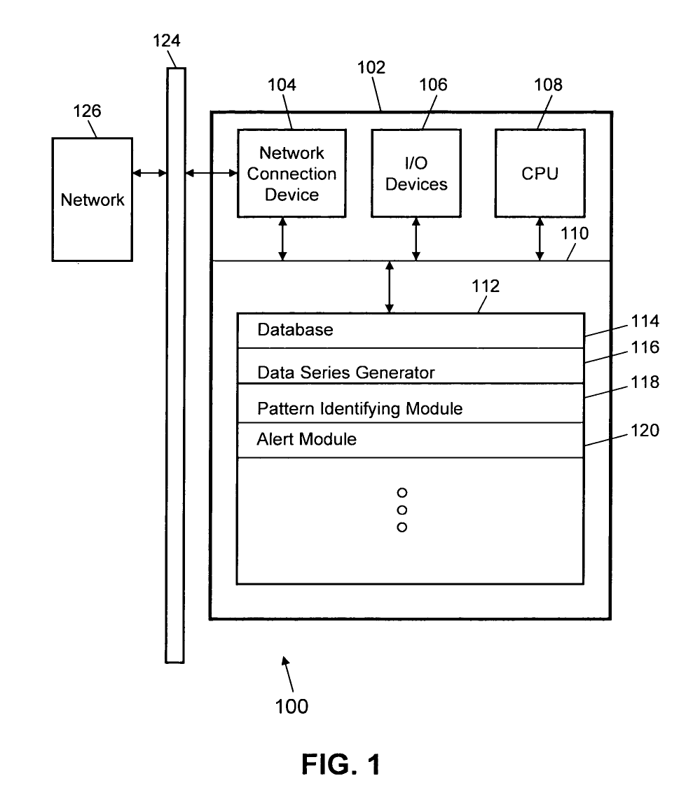

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a display, a printer, a speaker, and so forth) via a bus 110. The network connection device 104 is connected to network 126 through a network transport medium 124, which may be any wired or wireless transport medium.

The CPU 108 is also connected to a memory 112 via the bus 110. The memory 112 stores a set of executable programs. One executable program is the data series generator 116. The data series generator 116 includes executable instructions to access a data source to produce a set of data series comprising various business records. By way of example, the data source may be database 114 resident in memory 112. The data source may be located anywhere in the network 126. A data series is a collection of data values. The data values may be recorded for one or more given variables at different periods over time.

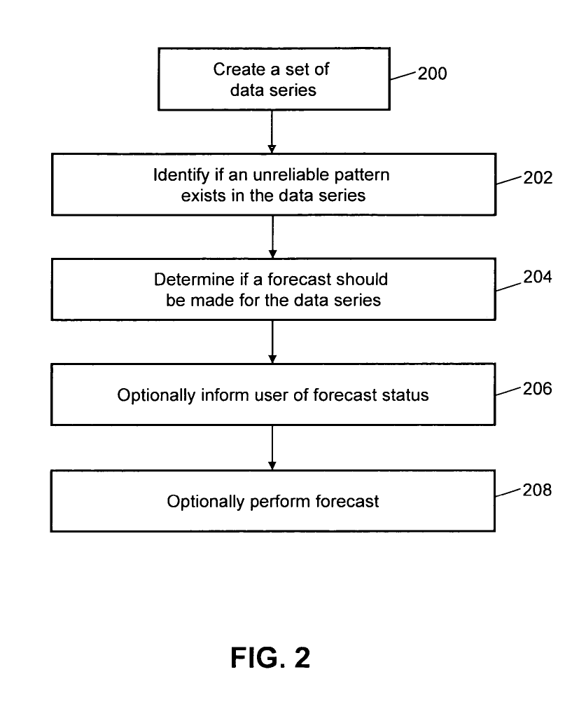

As shown in FIG. 1, the memory 112 also contains a pattern identifying module 118. The pattern identifying module 118 identifies if any unreliable pattern exists in a given data series that suggests that a forecast should not be made for the series. The pattern identifying module 118 includes executable instructions to access a data source to process a set of business data values. By way of example, the data source may be database 114 resident in memory 112. The pattern identifying module 118 can operate in conjunction with the alert module 120 to inform the user of the results of any identification made by the pattern identifying module 118. In one embodiment of the invention, the pattern identifying module 118 identifies any unreliable patterns present in the set of data series generated by the data series generator 116 according to the processing operations illustrated in FIG. 2.

While the various components of memory 112 are shown residing in the single computer 102, it should be recognized that such a configuration is not required in all applications. For instance, the pattern identifying module 118 may reside in a separate computer (not shown in FIG. 1) that is connected to the network 126. Similarly, separate modules of executable code are not required. The invention is directed toward the operations disclosed herein. There are any number of ways and locations to implement those operations, all of which should be considered within the scope of the invention.

FIG. 2 illustrates processing operations associated with an embodiment of the invention. The first processing operation shown in FIG. 2 is to create a set of data series 200. In one embodiment of the invention, this is implemented with executable code of the data series generator 116. In one embodiment, the data series generator 116 produces a collection of data values for different variables, 1 to n, recorded over a specified number of periods, 1 to m. The business data values may represent various business records or other events in a business. Accordingly, the set of data series characterizes various business data values for different variables recorded over a specified number of periods.

Tools existing in the prior art may subsequently begin to forecast future data values for a given variable in a data series by identifying any patterns that exist in the data series. However, some variables are distinguished by particular patterns that result in highly unreliable and inaccurate forecasts. Conducting forecasts on these variables is highly ineffective and results in an inefficient use of computing resources. Therefore, these variables should either be omitted from any future forecast or the user should be warned before any forecast is made.

Returning to FIG. 2, the next processing operation is to identify if any unreliable pattern exists in data series 202 generated by the data series generator 116. The pattern identifying module 118 may identify any unreliable patterns that are present in each data series generated by the data series generator 116. The presence of any of the unreliable patterns in a data series indicates that a forecast made for the data series will be untrustworthy. By way of example, the unreliable patterns may include outlier patterns, step change patterns, and random behavior patterns. These patterns can be identified using the techniques described in the commonly owned patent application entitled “Apparatus and Method for Identifying Patterns in a Multi-Dimensional Database”, Ser. No. 10/113,917, filed Mar. 28, 2002, the contents of which are incorporated herein by reference. Various statistical tests may be employed to identify these patterns, including a Tukey's test, a Standard Deviation test, a Runs test, an Autocorrelation test, and a Mean Squared Successive Difference test.

As shown in FIG. 2, the next processing operation is to determine if a forecast should be made for each data series 204. The pattern identifying module 118 may determine if a forecast should be made based on the existence of any unreliable patterns identified in each data series. If any unreliable pattern was identified in a data series, the pattern identifying module 118 may determine that a forecast should not be made for the data series and the data series will be discarded for any forecast made for the remainder of the data series.

Returning to FIG. 2, the next processing operation is for the alert module 120 to optionally inform the user of the forecast status 206. The alert module 120 may notify the user of any data series that was identified as containing an unreliable pattern that is not useful. By way of example, the notification may be delivered via an email message. Alternatively, the alert may be a visual indicator, such as a user interface screen.

Ultimately, by identifying those data series that fit an unreliable pattern, a business may avoid obtaining an unreliable forecast. Additionally, a business can efficiently save computing resources that would otherwise be wasted on conducting untrustworthy forecasts. Thus, the invention provides a business the ability to efficiently select those data series that will result in reliable forecasts. Those forecasts may be performed in accordance with the last operation 208 of FIG. 2. The forecasts may only be directed to patterns that have not been classified as unreliable. Alternately, the forecasts may relate to patterns that have been deemed unreliable. However, in this situation, the user has been forewarned of the potentially untrustworthy forecast.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt to a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A computer-readable medium to direct a computer to function in a specified manner, comprising executable instructions to:
generate a data series characterizing data values;
identify any unreliable pattern present in the data series; and
determine if a forecast should be made for the unreliable pattern.

2. The computer-readable medium of claim 1, wherein the executable instructions to identify includes executable instruction to detect at least one of an outlier pattern, a step change pattern, and a random behavior pattern.

3. The computer-readable medium of claim 2, wherein the executable instructions to identify includes executable instructions to apply a statistical test to the data series.

4. The computer-readable medium of claim 3, wherein the statistical test is selected from a Tukey test, a Standard Deviation test, a Runs test, an Autocorrelation test, and a Mean Squared Successive Difference test

5. The computer-readable medium of claim 1, further comprising executable instructions to report an alert of the unreliable pattern.

6. The computer-readable medium of claim 5, wherein the executable instructions to report an alert include executable instructions to generate an email alert.

7. The computer-readable medium of claim 5, wherein the executable instructions to report an alert include executable instructions to present a visual indication of an unreliable pattern.

8. A computer implemented method of processing data, comprising:
creating data values;
identifying an unreliable pattern in the data values; and
determining if a forecast should be made for the unreliable pattern.

9. The method of claim 8, wherein the unreliable pattern is selected from an outlier pattern, a step change pattern, and a random behavior pattern.

10. The method of claim 9, wherein identifying an unreliable pattern includes applying statistical tests to the data values.

11. The method of claim 10, wherein the statistical test is selected from a Tukey test, a Standard Deviation test, a Runs test, an Autocorrelation test, and a Mean Squared Successive Difference test.

12. The method of claim 8, further comprising informing the user of the unreliable pattern.

13. The method of claim 12, wherein informing the user of the unreliable pattern includes sending an email.

14. The method of claim 12, wherein informing the user of the unreliable pattern includes producing a visual indication of an unreliable pattern.
